(19) United States
(12) Patent Application Publication
(10) Pub. No.: US 2013/0187494 A1
(43) Pub. Date: Jul. 25, 2013

(54) STATOR ASSEMBLY FOR AN ELECTRIC MACHINE

(71) Applicants: Colin Hamer, Noblesville, IN (US); Richard Trammell, Noblesville, IN (US); Brad Chamberlin, Pendleton, IN (US)

(72) Inventors: Colin Hamer, Noblesville, IN (US); Richard Trammell, Noblesville, IN (US); Brad Chamberlin, Pendleton, IN (US)

(73) Assignee: REMY TECHNOLOGIES, L.L.C., Pendleton, IN (US)

(21) Appl. No.: 13/357,644

(22) Filed: Jan. 25, 2012

(51) Int. Cl. H02K 3/28; H02K 15/085; H02K 3/48

(52) U.S. Cl. 310/71; 310/201; 29/596

(57) ABSTRACT

A stator assembly includes a first conductor having a first leg portion, and second leg portion. Each of the first and second leg portions includes corresponding first and second free end portions. The first free end portion includes first and second surface portions and the second free end portion includes first and second surface segments. A second conductor includes a first leg section, and a second leg section including corresponding first and second free end sections. The first free end section includes first and second surface zones and the second free end section including first and second surface sectors. The second free end portion and the first free end section are twisted creating a cross-over region causing the first surface portion to abut the second surface zone. The second free end portion is joined to the first free end section through a bond that exists at the cross-over region.

### BACKGROUND OF THE INVENTION

Exemplary embodiments pertain to the art of electric machines and, more particularly, to a stator assembly for an electric machine.

In certain electric machines, a stator winding is formed from one or more conductors wound throughout slots formed in a stator core. In other electric machines, the stator windings take the form of individual conductors that are inserted into the slots. The individual windings, often referred to as hairpin windings, are pre-formed from round or rectangular wire. The wires are formed in a hairpin shape having first and second legs that are inserted into the slots. Free ends of the legs project out from the stator core and are selectively joined to another one or more of the wires to form the stator winding. The free ends are twisted/bent and aligned with a free end of another wire. After alignment, the free ends are joined, by a welding or soldering process to establish an electrical joint.

### BRIEF DESCRIPTION OF THE INVENTION

Disclosed is a stator assembly includes a stator core having a first outer edge portion, a second, opposing outer edge portion and a plurality of slot segments extending between the first and second outer edge portions. A first conductor includes a first leg portion and a second leg portion. Each of the first and second leg portions includes corresponding first and second free end portions and is arranged in select ones of the plurality of slot segments. The first free end portion includes first and second opposing surface portions and the second free end portion includes first and second opposing surface segments. A second conductor includes a first leg section and a second leg section. Each of the first and second leg sections includes corresponding first and second free end sections and is arranged in other select ones of the plurality of slot segments. The first free end section includes first and second opposing surface zones and the second free end section including first and second opposing surface sectors. Each of the second free end portion and the first free end section are twisted creating a cross-over region causing the first surface portion to abut the second surface zone. The second free end portion is joined to the first free end section through a bond that exists at the cross-over region.

Also disclosed is a method of forming stator windings in a stator assembly. The method includes positioning first and second leg portions of a first conductor in select ones of slot segments of a stator core having an edge such that first and second free end portions of the first and second leg portions extend beyond the edge, positioning first and second leg sections of a second conductor in other select ones of the slot segments of the stator core such that first and second free end sections of the first and second leg portions extend beyond the edge, twisting the second free end portion and the first free end section to form cross-over region, bonding the first free end portion to the first free end section at the cross-over region, and removing portions of the second free end portion and the first free end section that extend beyond the cross-over region

Further disclosed is an electric machine including a housing, a rotor rotatably mounted relative to the housing, and a stator assembly fixedly mounted relative to the rotor. The stator assembly includes a stator core having a first outer edge portion, a second, opposing outer edge portion and a plurality of slot segments extending between the first and second outer edge portions. A first conductor includes a first leg portion and a second leg portion. Each of the first and second leg portions includes corresponding first and second free end portions and is arranged in select ones of the plurality of slot segments. The first free end portion includes first and second opposing surface portions and the second free end portion includes first and second opposing surface segments. A second conductor includes a first leg section and a second leg section. Each of the first and second leg sections includes corresponding first and second free end sections and is arranged in other select ones of the plurality of slot segments. The first free end section includes first and second opposing surface zones and the second free end section including first and second opposing surface sectors. Each of the second free end portion and the first free end section are twisted creating a cross-over region causing the first surface portion to abut the second surface zone. The second free end portion is joined to the first free end section through a bond that exists at the cross-over region.

### BRIEF DESCRIPTION OF THE DRAWINGS

The following descriptions should not be considered limiting in any way. With reference to the accompanying drawings, like elements are numbered alike:

FIG. 1 depicts an electric machine including a stator assembly constructed in accordance with an exemplary embodiment;

FIG. 2 depicts a partial perspective view of a stator assembly of the electric machine of FIG. 1;

FIG. 3 depicts a plan view of first and second conductors arranged in the stator assembly of FIG. 2;

FIG. 4 depicts a plan view of the first and second conductors of FIG. 3 following a twisting process forming a cross-over region and a bonding process joining the first and second conductors at the cross-over region;

FIG. 5 depicts a plan view of the first and second conductors of FIG. 4 following removal of end portions of the first and second conductors that extend beyond the cross-over region;

FIG. 6 is a plan view of the first and second conductors joined at the cross-over region using a clip;

FIG. 7 is a plan view of the first and second conductors of FIG. 6 following removal of end portions of the first and second conductors that extend beyond the cross-over region; and

FIG. 8 is a partial perspective view of the stator assembly of FIG. 2 after bonding stator winding conductors in accordance with the exemplary embodiment.

### DETAILED DESCRIPTION OF THE INVENTION

A detailed description of one or more embodiments of the disclosed apparatus and method are presented herein by way of exemplification and not limitation with reference to the Figures.

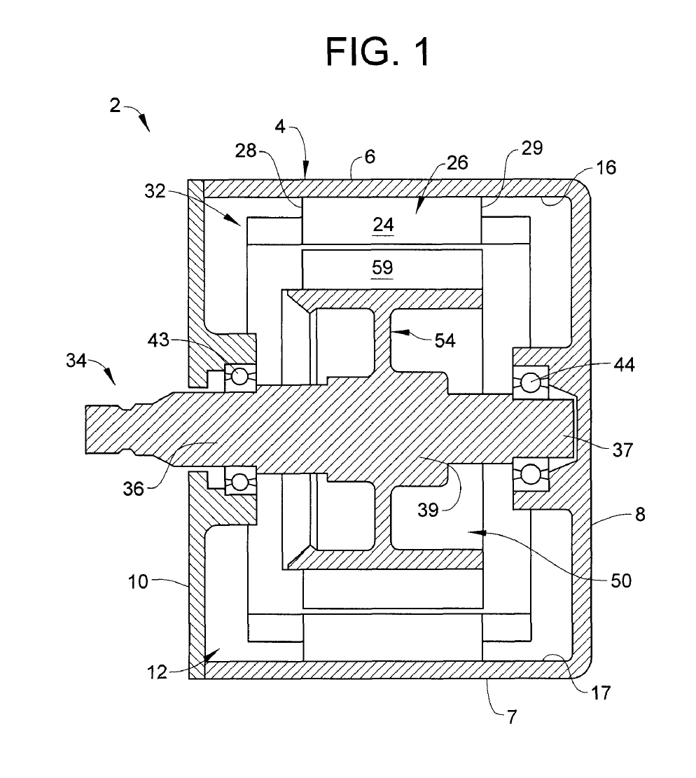

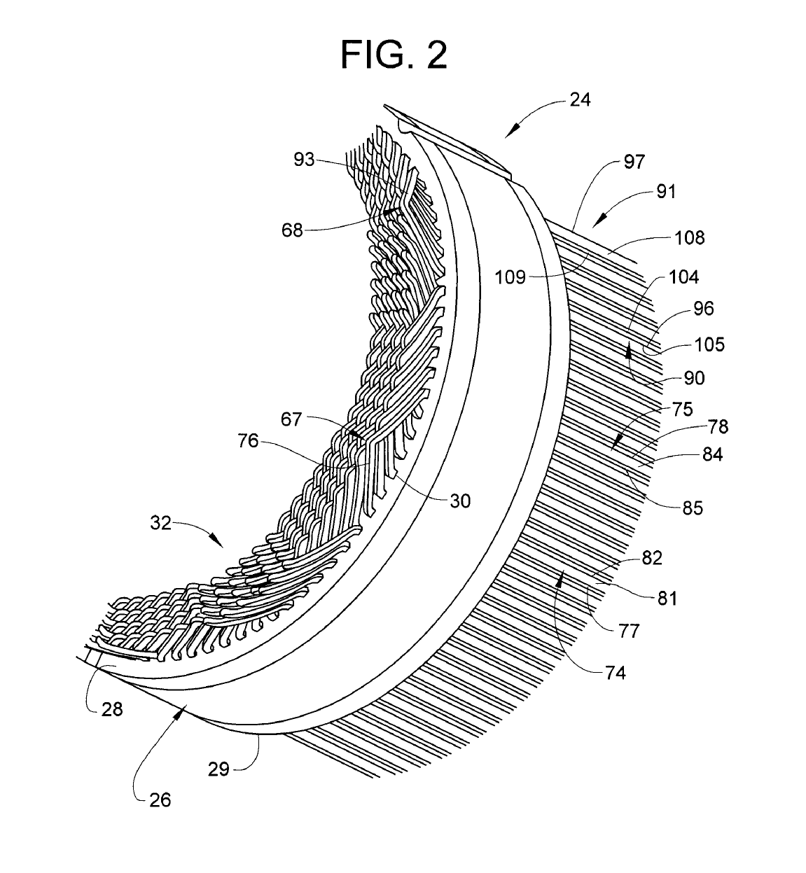

An electric machine in accordance with an exemplary embodiment is indicated generally at 2 in FIG. 1. Electric machine 2 includes a housing 4 having first and second side walls 6 and 7 that are joined by a first end wall 8 and a second end wall or cover 10 to collectively define an interior portion 12. First side wall 6 includes an inner surface 16 and second side wall 7 includes an inner surface 17. At this point it should be understood that housing 4 could also be constructed to include a single side wall having a continuous inner surface. Electric machine 2 is further shown to include a stator assembly 24 arranged at inner surfaces 16 and 17 of first and second side walls 6 and 7. Stator assembly 24 includes a stator core 26 having a first outer edge portion 28, a second, opposing outer edge portion 29, and a plurality of slot segments, one of which is indicated at 30 (FIG. 2). Slot segments 30 extend between first and second outer edge portions 28 and 29. Stator 24 includes a plurality of stator windings 32 that are arranged within slot segments 30 as will be discussed more fully below.

Electric machine 2 is also shown to include a shaft 34 rotatably supported to housing 4. Shaft 34 includes a first end 36 that extends to a second end 37 through an intermediate portion 39. First end 36 is rotatably supported relative to second end wall 10 through a first bearing 43 and second end 37 is rotatably supported relative to first end wall 8 through a second bearing 44. Shaft 34 supports a rotor assembly 50 that is rotatably mounted within housing 4. Rotor assembly 50 includes a rotor hub 54 that is fixed relative to intermediate portion 39 of shaft 34, and a rotor lamination 59 that is configured to rotate relative to stator assembly 24.

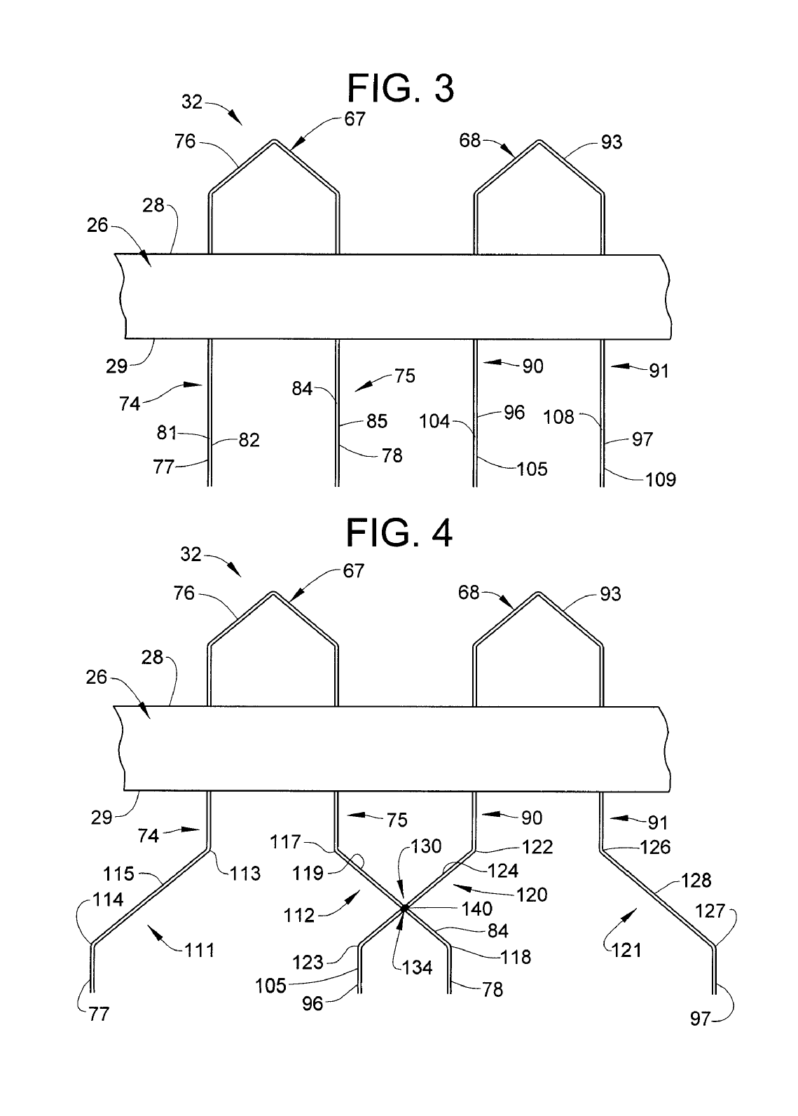

As shown in FIGS. 2-4, stator windings 32 are formed from a plurality of stator winding conductors, two of which are indicated at 67 and 68. Stator winding conductors 67 and 68 are joined to each other and to additional stator winding conductors (not separately labeled) to form a phase winding (also not separately labeled). Stator winding 67 includes first and second leg portions 74 and 75 that are joined by a crown portion 76. First and second leg portions 74 and 75 extend through slot segments 30 of stator core 26. First leg portion 74 includes a first free end portion 77 and second leg portion 75 includes a second free end portion 78. As shown, first and second free end portions 77 and 78 extend beyond second outer edge portion 29 of stator core 26. First free end portion 77 includes first and second opposing surface portions 81 and 82. Second free end portion 78 includes first and second opposing surface segments 84 and 85. At this point it should be understood that while shown as having a rectangular cross-section, stator winding conductor 67 could have a circular cross-section. In such an arrangement, opposing surface portions 81, 82 and opposing surface segments 84, 85 would define opposing sides the circular cross-section.

In a similar manner, stator winding conductor 68 includes first and second leg sections 90 and 91 that are joined by a crown section 93. First and second leg sections 90 and 91 extend through others of the plurality of slot segments 30 formed in stator core 26. First leg section 90 includes a first free end section 96 and second leg section 91 includes a second free end section 97. First and second free end sections 96 and 97 extend beyond second outer edge portion 29 of stator core 26. First free end section 96 includes first and second opposing surface zones 104 and 105. Likewise, second free end section 97 includes first and second opposing surface sectors 108 and 109. As will be detailed more fully below, second leg portion 75 is joined to first leg section 90 to establish an electrical connection between stator winding conductors 67 and 68. Of course it should be understood that first leg portion 74 and second leg section 91 are joined to other stator winding conductors (not separately labeled) to form a phase winding (also not separately labeled) for stator assembly 24. At this point it should be understood that while shown as having a rectangular cross-section, stator winding conductor 68 could have a circular cross-section. In such an arrangement, opposing surface zones 104, 105 and opposing surface sectors 108, 109 define opposing sides the circular cross-section.

In accordance with the exemplary embodiment, first and second leg portions 74 and 75 are twisted to form corresponding first and second twisted regions 111 and 112. Twisted region 111 includes a first bend portion 113 and a second bend portion 114 that form an angled portion 115. Similarly, second twisted region 112 includes a first bend portion 117 and a second bend portion 118 that form an angled portion 119. In a manner similar to that described above, first and second free end sections 96 and 97 are twisted to form corresponding first and second twisted zones 120 and 121. First twisted zone 120 includes a first bend section 122 and a second bend section 123 that form an angled section 124. Likewise, second twisted zone 121 includes a first bend section 126 and a second bend section 127 that form an angled section 128.

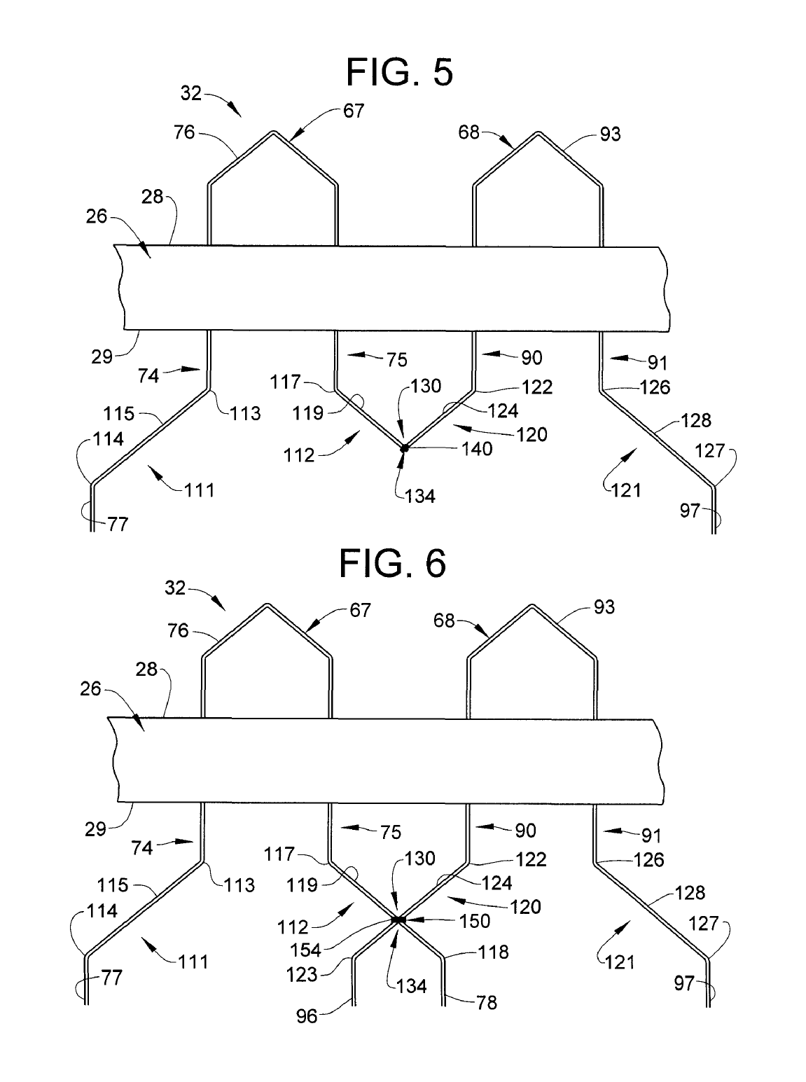

With this arrangement, second free end portion 78 is positioned relative to first free end section 96 such that first surface segment 84 abuts second surface zone 105 creating a cross-over region 130. Once in position, a bond 134 is formed between second free end portion 78 and first free end section 96 at cross-over region 130. Bond 134 exists only between first surface segment 84 and second surface zone 105. That is, bond 134 does not extend substantially beyond cross-over region 130. In this manner, remaining portions of second free end portion 78 and first free end section 96 can be removed without effecting bond 134 or any electrical connection between stator winding conductor 67 and stator winding conductor 68 such as shown in FIG. 5.

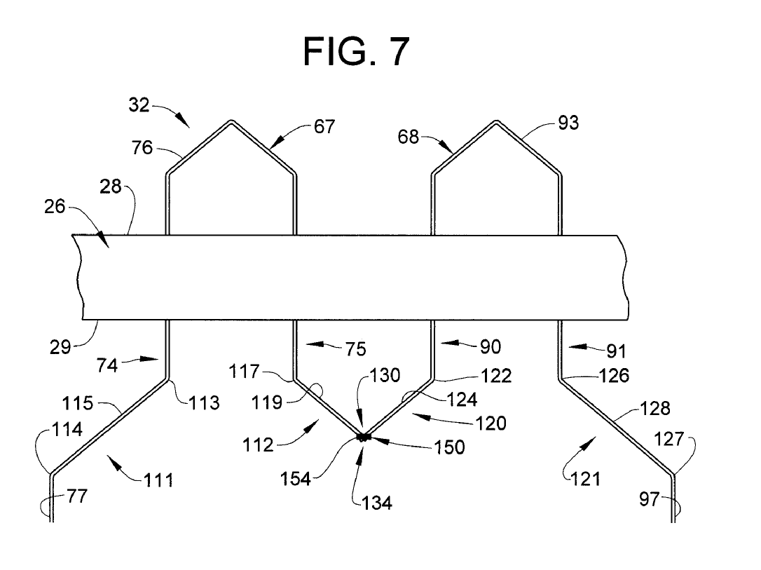

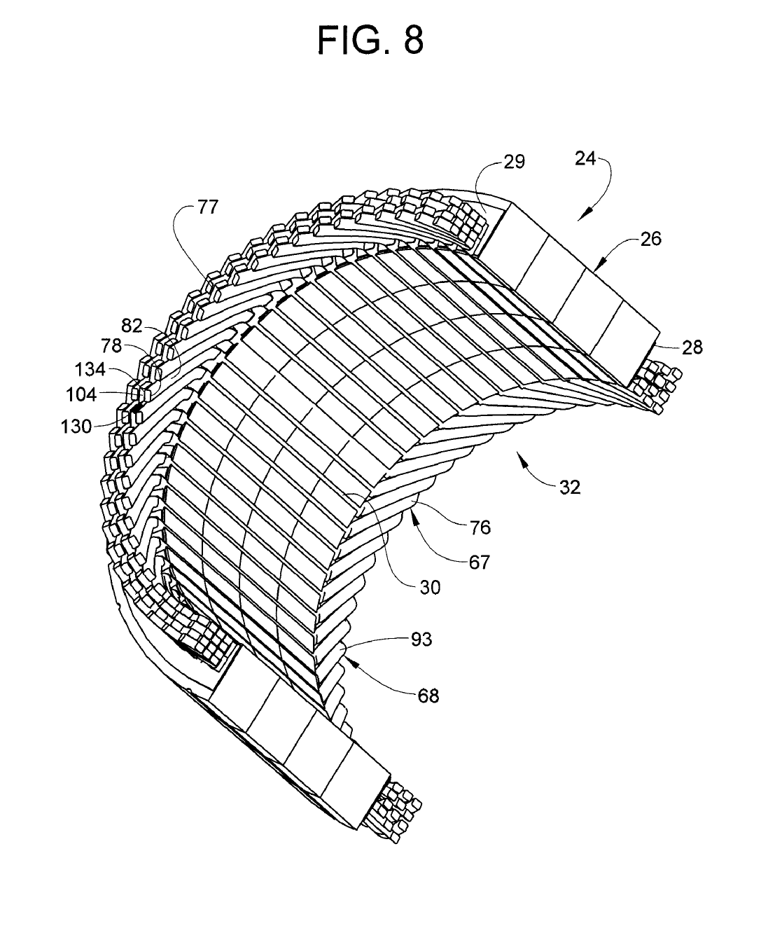

In accordance with one aspect of the exemplary embodiment, bond 134 takes the form of a heated coupling 140. Heated coupling 140 may take the form of a welded bond or a soldered bond. In accordance with another aspect of the exemplary embodiment illustrated in FIGS. 6 and 7, bond 134 may take the form of a non-heated coupling 150. Non-heated coupling 150 may include a clip such as shown at 154, a clamp (not shown) or a crimped connection (also not shown). Regardless of the type of bond, the exemplary embodiments provide a system for joining stator winding conductors. In particular, the exemplary embodiments provide a system for removing portions of stator winding connectors that extend beyond a bond that joins the stator winding conductors at a cross-over region. The removal of the portions of the stator windings that extend beyond the bond leads to a stator assembly having a reduced form factor such as shown in FIG. 8.

At this point it should be understood that the exemplary embodiments can be employed to bond conductors that are not joined through a crown section. More specifically, while shown joining free ends of the stator windings that extend beyond a single outer edge of the stator core, the exemplary embodiments can be employed to join free ends that extend beyond both outer edge portions of the stator core. Also, while shown in connection with joining stator windings having a hair-pin configuration, the exemplary embodiments can be employed to join a wide variety of stator winding conductors including single conductors having free ends that extend beyond each outer edge portion of the stator core.

The removal of any remaining portions of the conductors that extend beyond the bond represents an additional process in the overall manufacturing of a stator. The removal of the remaining portions also introduces a need for heightened manufacturing supervision. That is, personnel must ensure that the removed portions do not become entangled in the stator core or the stator windings. In addition, when using a heated coupling technique, care must be taken to ensure that any insulation on the stator winding conductors is not damaged. These additional manufacturing costs however allow stator winding 32 to have a reduced form factor that leads to a decrease in overall package size of the stator assembly. The reduction in package size allows for the incorporation of additional stator windings and for a reduction in stator core length that provides an increase in output from electric machine 2. It has been found that the reduction of the twisted region 112 and the incorporation of additional windings and reduced stator core length may lead to as much as a 30 horsepower or more gain in output without increasing an overall package size of the electric machine.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof Therefore, it is intended that the invention not be limited to the particular embodiment disclosed as the best mode contemplated for carrying out this invention, but that the invention will include all embodiments falling within the scope of the claims.

What is claimed is:

1. A stator assembly comprising:
a stator core including a first outer edge portion, a second, opposing outer edge portion and a plurality of slot segments extending between the first and second outer edge portions;
a first conductor having a first leg portion and a second leg portion, each of the first and second leg portions including corresponding first and second free end portions and are arranged in select ones of the plurality of slot segments, the first free end portion including first and second opposing surface portions and the second free end portion including first and second opposing surface segments; and
a second conductor having a first leg section and a second leg section, each of the first and second leg sections including corresponding first and second free end sections and are arranged in other select ones of the plurality of slot segments, the first free end section including first and second opposing surface zones and the second free end section including first and second opposing surface sectors, wherein each of the second free end portion and the first free end section is twisted creating a cross-over region causing the first surface portion to abut the second surface zone, the second free end portion being joined to the first free end section through a bond that exists at the cross-over region.

2. The stator assembly according to claim 1, wherein the first surface portion is joined to the second surface zone by a heated coupling.

3. The stator assembly according to claim 2, wherein the heated coupling comprises a welded bond.

4. The stator assembly according to claim 2, wherein the heated coupling comprises a soldered bond.

5. The stator assembly according to claim 1, wherein the first surface portion is joined to the second surface zone by a non-heated coupling.

6. The stator assembly according to claim 1, wherein the non-heated coupling comprises a clip.

7. The stator assembly according to claim 1, wherein the second free end portion and the first free end section do not extend substantially beyond the cross-over region.

8. A method of forming stator windings in a stator assembly comprising:
positioning first and second leg portions of a first conductor in select ones of slot segments of a stator core having an edge such that first and second free end portions of the first and second leg portions extend beyond the edge;
positioning first and second leg sections of a second conductor in other select ones of the slot segments of the stator core such that first and second free end sections of the first and second leg portions extend beyond the edge;
twisting the second free end portion and the first free end section to form a cross-over region;
bonding the first free end portion to the first free end section at the cross-over region; and
removing portions of the second free end portion and the first free end section that extend beyond the cross-over region.

9. The method of claim 8, wherein bonding the second end portion to the first end section includes abutting a first surface portion of the second free end portion with a second surface zone of the first free end section.

10. The method of claim 9, wherein bonding the second free end portion to the first free end section includes bonding only the first surface portion and the second surface zone.

11. The method of claim 8, wherein bonding the second free end portion to the first free end section includes soldering the second free end portion to the first free end section.

12. The method of claim 8, wherein bonding the second free end portion to the first free end section includes welding the second free end portion to the first free end section.

13. The method of claim 8, wherein bonding the second free end portion to the first free end section includes clipping the second free end portion to the first free end section.

14. An electric machine comprising:
a housing;
a rotor rotatably mounted relative to the housing; and
a stator assembly fixedly mounted relative to the rotor, the stator assembly comprising:
a stator core including a first outer edge portion, a second, opposing outer edge portion and a plurality of slot segments extending between the first and second outer edge portions;
a first conductor having a first leg portion and a second leg portion, each of the first and second leg portions including corresponding first and second free end portions and are arranged in select ones of the plurality of slot segments, the first free end portion including first and second opposing surface portions and the second free end portion including first and second opposing surface segments; and
a second conductor having a first leg section and a second leg section, each of the first and second leg sections including corresponding first and second free end sections and are arranged in other select ones of the plurality of slot segments, the first free end section including first and second opposing surface zones and the second free end section including first and second opposing surface sectors, wherein each of the second free end portion and the first free end section is twisted creating a cross-over region causing the first surface portion to abut the second surface zone, the second free end portion being joined to the first free end section through a bond at the cross-over region.

15. The electric machine according to claim 14, wherein the first surface portion is joined to the second surface zone by a heated coupling.

16. The electric machine according to claim 15, wherein the heated coupling comprises a welded bond.

17. The electric machine according to claim 15, wherein the heated coupling comprises a soldered bond.

18. The electric machine according to claim 14, wherein the first surface portion is joined to the second surface zone by a non-heated coupling.

19. The electric machine according to claim 14, wherein the non-heated coupling comprises a clip.

20. The electric machine according to claim 14, wherein the first free end portion and the first free end section terminate at the bond.
